(19) United States
(12) Patent Application Publication
(10) Pub. No.: US 2017/0282637 A1
(43) Pub. Date: Oct. 5, 2017

(54) Stained Glass Assembly for Doors, Wall Partitions or the Likes

(71) Applicant: Vitre-Art Inc., Montreal (CA)

(72) Inventor: Nicolas Barazin, Montreal (CA)

(73) Assignee: Vitre-Art Inc.

(21) Appl. No.: 15/091,304

(22) Filed: Apr. 5, 2016

(51) Int. Cl. B44F 1/06; E06B 3/54; B44C 5/08

(52) U.S. Cl. CPC B44F 1/06; B44C 5/08; E06B 3/5454

(57) ABSTRACT

The problem of using cames for assembling stained glass pieces into a decorative window is solved by mounting the stained glass pieces in retaining channels and by using spacers in the retaining channel for maintaining gaps between adjacent stained glass pieces. The resulting stained glass assembly includes at least two stained glass pieces mounted within a frame and being secured in at least one retaining channel that is mounted to the frame so as to extend at least partially along the inner periphery thereof; and spacers in the retaining channel between each pair of the at least two stained glass pieces that are adjacent so as to create an opened gap therebetween. Such a stained glass assembly can be used as a decorative window in a door or as a dividing wall for example.

### BACKGROUND

The stained glass technique is well-known since hundreds of years, wherein pieces of glass are arranged to form patterns or pictures, held traditionally together by strips of lead and supported by a rigid frame. In particular, it is also long been known to provide stained glass windows in high-end doors.

Cames are conventionally used to join the pieces of glass, wherein H-shaped sections hold two pieces together, and U-shaped sections are used for the borders.

However, the steps of cutting and shaping the cames and of mounting the pieces of glass therein has been found both material and labour expensive.

Also, as a further drawback in the case of a stained glass assembly included in a door, it has been found challenging to match the metal texture of the cames with those of the door hardware.

### SUMMARY

The problem of using cames for assembling stained glass pieces into a decorative window is solved by mounting the stained glass pieces in retaining channels and by using spacers in the retaining channel for maintaining gaps between adjacent stained glass pieces.

According to an illustrative embodiment, there is provided a stained glass assembly comprising glass pieces mounted to a frame via retaining channels; the retaining channels having spacers therein for maintaining gaps between adjacent glass pieces.

According to another illustrated embodiment, a stained glass assembly comprises:

at least two stained glass pieces mounted within a frame and being secured in at least one retaining channel that is mounted to the frame so as to extend at least partially along the inner periphery thereof; and

spacers in the at least one retaining channel between each pair of the at least two stained glass pieces that are adjacent so as to create an opened gap therebetween.

Other objects, advantages and features of the stained glass assembly for doors, wall partitions or the likes will become more apparent upon reading the following nonrestrictive description of illustrated embodiments thereof, given by way of example only with reference to the accompanying drawings.

### BRIEF DESCRIPTION OF THE DRAWINGS

In the appended drawings:

FIG. 1 is a perspective view of a door provided with a stained glass assembly according to a first illustrated embodiment;

FIGS. 2A and 2B are cross sections of the stained glass assembly from FIG. 1, illustrating the mounting of a piece of glass in one of the channels;

FIG. 3 is a partial perspective of the assembly from FIG. 2B;

FIG. 4A is a close up perspective illustrating the use of a spacer in the channels to force a distanced relationship between two pieces of the glass of the stained glass assembly from FIG. 1;

FIG. 4B is a close up perspective illustrating the use of protrusions in the channels to force a distanced relationship between two pieces of the glass of the stained glass assembly from FIG. 1;

FIG. 5 is a perspective of a dividing wall according to a second illustrating embodiment; and

FIG. 6 is a cut out perspective of a door provided with a stained glass assembly according to a third illustrated embodiment, wherein the stained glass assembly includes two decorative window panels.

### DETAILED DESCRIPTION

In the following description, similar features in the drawings have been given similar reference numerals, and in order not to weigh down the figures, some elements are not referred to in some figures if they were already identified in a precedent figure.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements.

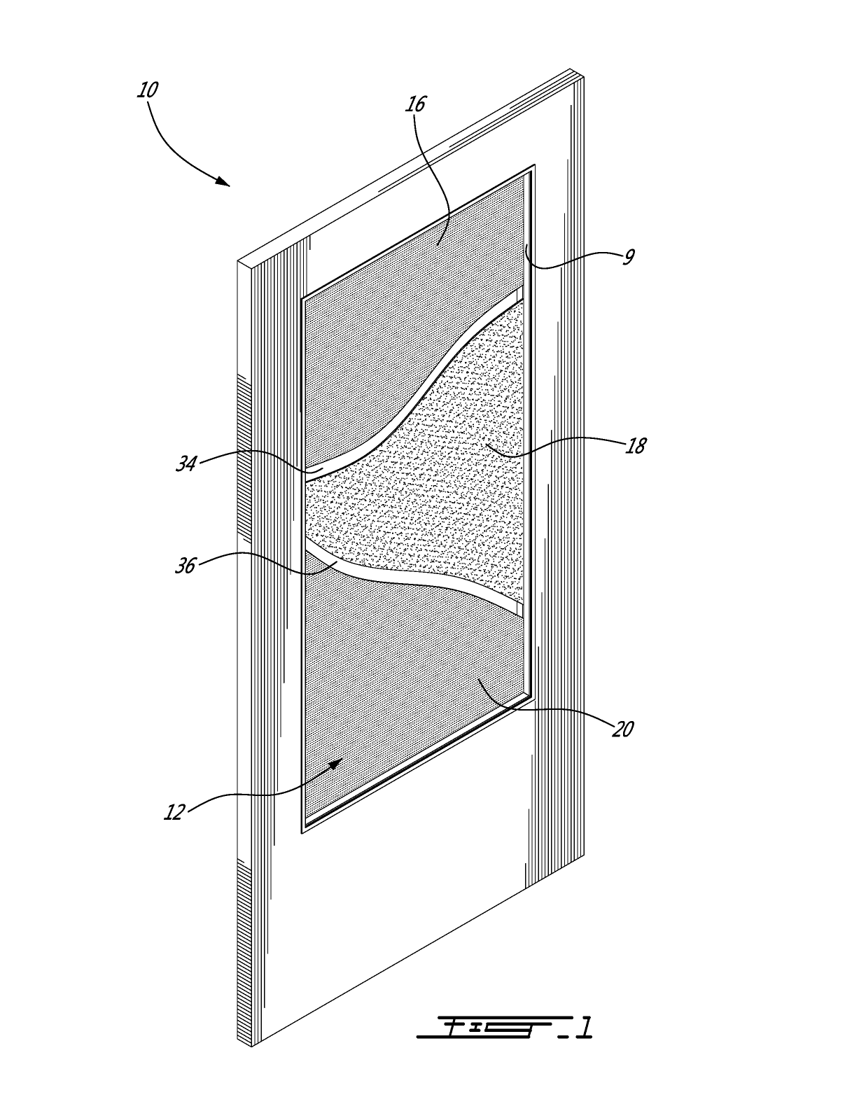

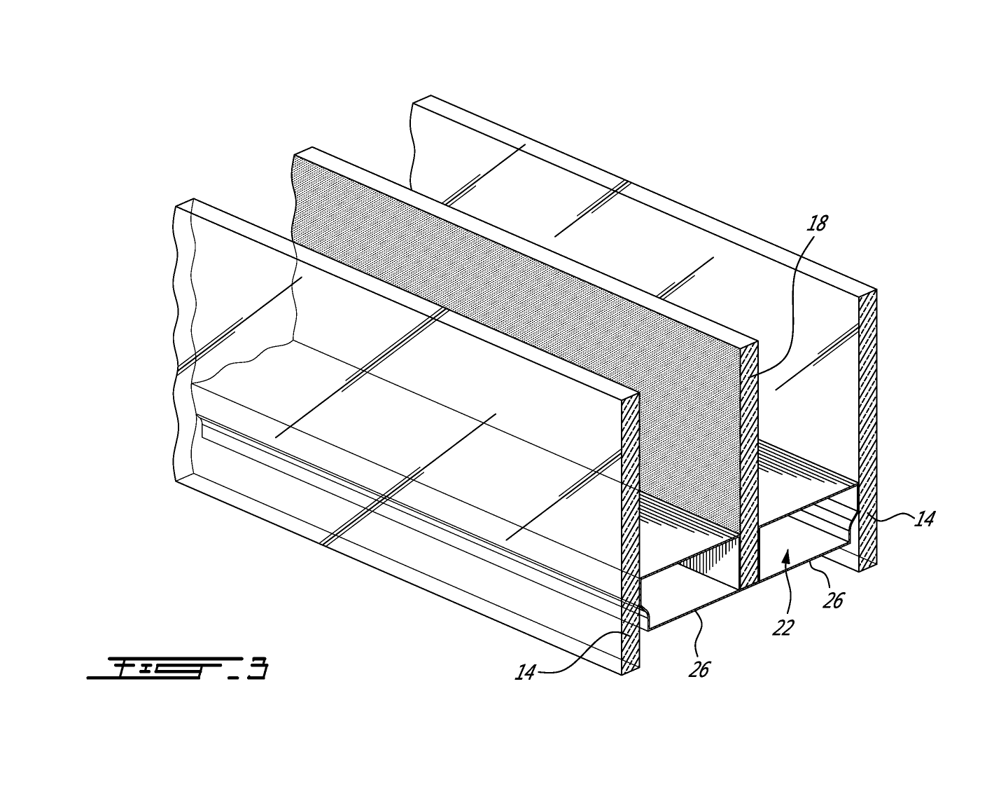

An exterior door 10 provided with a stained glass assembly 11 according to a first illustrated embodiment will now be described with reference to FIGS. 1-4A.

The door 10 includes rectangular opening 9 that defines a frame which receives a decorative window 12 therein. According to the first illustrated embodiment, the stained glass assembly 11 defines a decorative panel that is included in the decorative window 12 and is sandwiched between two glass panels 14 within the frame 9. The two glass panels 14 are conventionally secured to the door 12. Since the mounting and securing of conventional glass panels are believed to be well-known in the art, they will not be described herein in more detail.

The stained glass assembly 11 comprises three flat pieces of glass 16, 18 and 20 that are mounted within the frame 9 via retaining channels 22. The assembly 11 further comprises spacers 24 (four (4) according to the first illustrative embodiment) that creates opened gaps 34 and 36 between two adjacent pieces of glass 16-18 and 18-20.

The pieces of glass 16-20 can be transparent, frosted, colored and/or provided with patterns or marks. The number, dimensions and shapes of the glass pieces are dictated for example by aesthetic criteria. The resulting contour of the stained glass assembly 11 is however adapted for the geometry of the receiving frame.

The retaining channels 22 are made of aluminum and each includes two lateral tubular sections 26 distanced by a bridge portion 28. A slot 30 is defined by the bridge portion 28 and the two tubular sections 26 therebetween and yields a receiving portion for the side edge of the glass pieces 16-20.

According to the first illustrative embodiment, four retaining channels 22 are secured to the door 10 within the frame defined by the opening 9 using fasteners or an adhesive, each extending along a respective side of the frame 9. According to another embodiment, another number of channels 22 is provided so as to fully or partially cover the periphery of the opening 9.

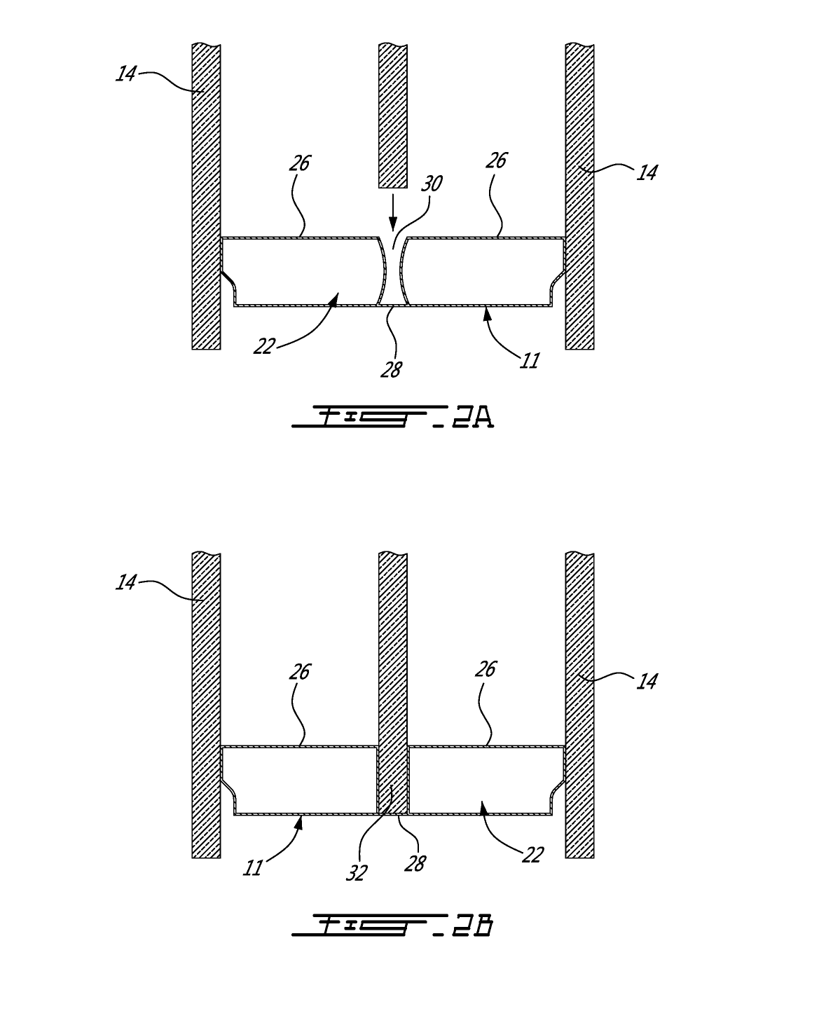

As can be better seen in FIG. 2A, the lateral tubular portions 26 are convex on the side of the bridge portion 28. It results that the slot 30 has a gradually decreasing width from the opening side thereof to about half its depth. The pieces of glass 16, 18 or 20 having a thickness generally corresponding to the widest section of the slot 30 and the tubular sections 26 being so shaped as to allow deformation thereof, the edge 32 of each piece of glass 16-20 is squeezed in the slot 30. This squeezing effect contributes to securing the stained glass pieces 16, 18 and 20 therein.

Also, each pieces of glass 16, 18 and 20 has two opposite and/or adjacent sides secured in a retaining channel 22, which further contributes to immobilizing the pieces of glass 16, 18 and 20 therein.

The width of the slot 32 is adapted for the thickness of the pieces of glass 16-20. Also, the channels 22 are not limited to being symmetrical, and/or they can also have a section different than the one illustrated in FIG. 2A.

According to another embodiment, the retaining channels are made of another material such as another metal or a polymeric material.

According to another embodiment (not shown) the tubular sections are replaced by a full section made of a compressible or deformable material.

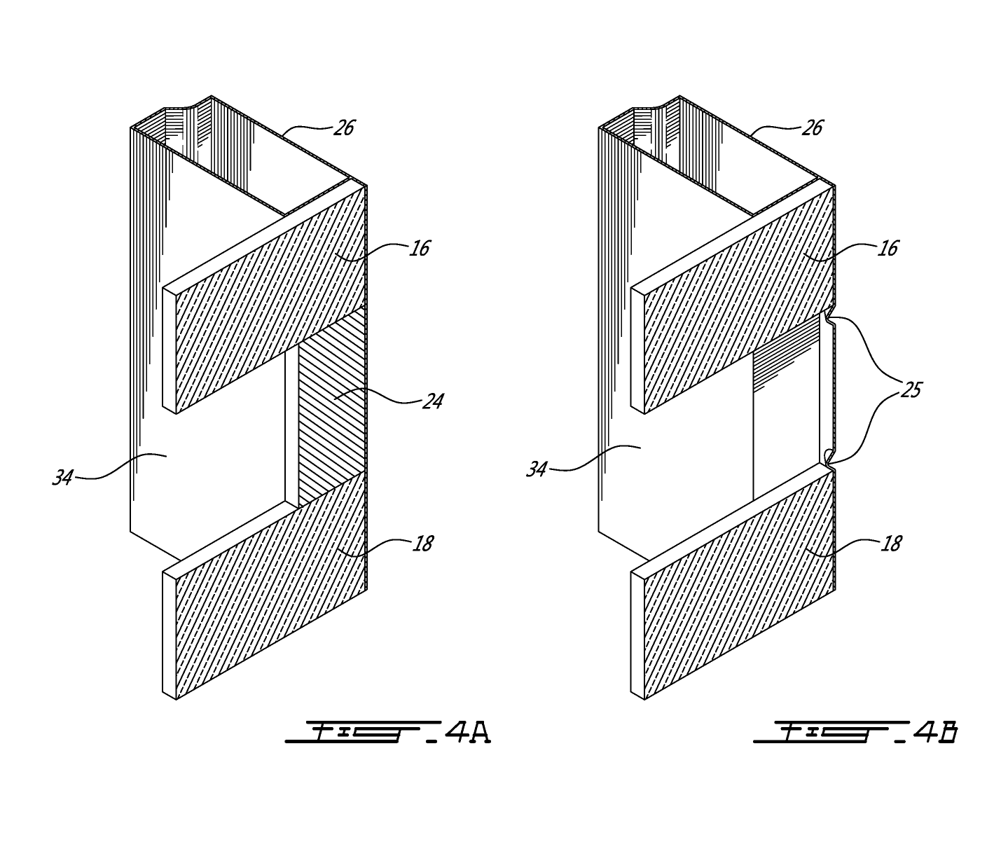

With reference more specifically to FIG. 4A, the spacers 24 are inserted in the channels 22 between two adjacent glass pieces 16-20, yielding open gaps 34 and 36 which call to mind soldering in conventional stained glass.

According to the first illustrated embodiment, the spacers 24 are in the form of small flat aluminum pieces having a width generally corresponding to the depth of the slots 30 and a thickness generally corresponding to the thickness of the pieces of glass 16-20. According to another embodiment, the spacers 24 have a width that is smaller or greater than the depth of the slots 30. According to still another embodiment, the spacers are made from another metallic material, or from a rigid non-metallic material such as a polymeric material.

While the spacers 24 according to the first illustrated embodiment have an identical height, they can also be different so as to yield different gaps between adjacent glass pieces and/or gaps that are not uniform between two adjacent pieces of glass (not shown).

As can be seen in FIG. 4B, the spacers can be in the form of a pair of protrusions 25 in the bridge portion 28 of the channels 22. Such protrusions 25 can be achieved by punching onto the bridge portion 28 on the backside thereof relative to the glass pieces 16-20. The protrusions 25 are longitudinally positioned relative to the glass pieces 16-20 so as to prevent movements thereof within the slot 30.

The dimensions of the protrusions can be different than those illustrated. For example, a single protrusion (not shown) can be provided that extends along the full height of the gap 34 or 36.

According to still another embodiment, the spacers are in the form of fasteners dimensioned to fit within the bridge portions 28 of the channels 22.

A stained glass assembly such as those described hereinabove is not limited to decorative windows for an exterior door. It can also be mounted to an interior door or to any door, wherein the two glass panels 14 can be omitted.

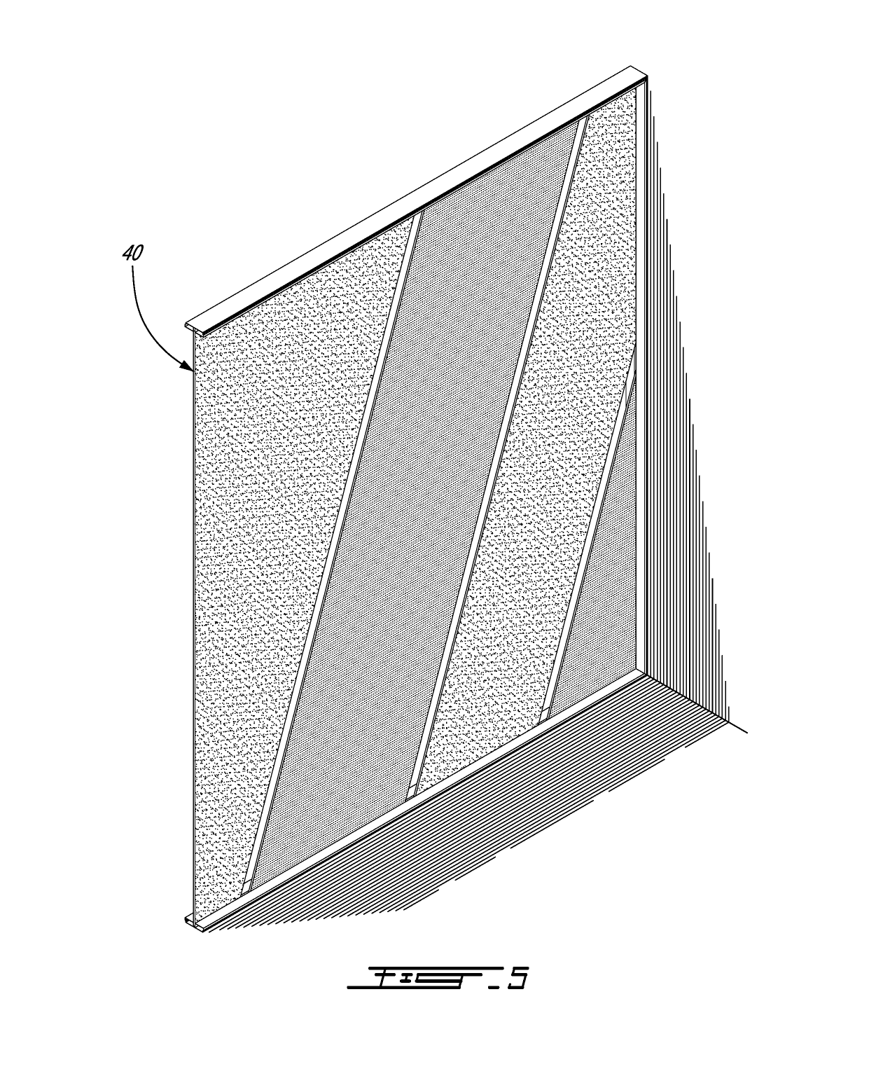

Also, as can be seen in FIG. 5, a stained glass assembly 40 according to a second illustrative embodiment is used as a dividing or baffle wall.

Also, embodiments of a stained glass assembly are not limited to include pieces of glass. Indeed, flat pieces of metal, wood, plastic, ceramic, or any combination thereof can also be used.

Also, as shown in FIG. 5, an illustrative embodiment of a stained gall assembly can be mounted to a frame that does not span 360 degrees. Also, according to some embodiment, channels 22 are provided only on opposite or adjacent sides of the frame. More generally, channels 22 can be provided only on selected portions of the periphery of the stained glass assembly in order to secure the stained glass assembly to a frame and to allow receiving spacers 24 or protrusions 25 at the appropriate positions to create gaps according to a predetermined stained glass pattern.

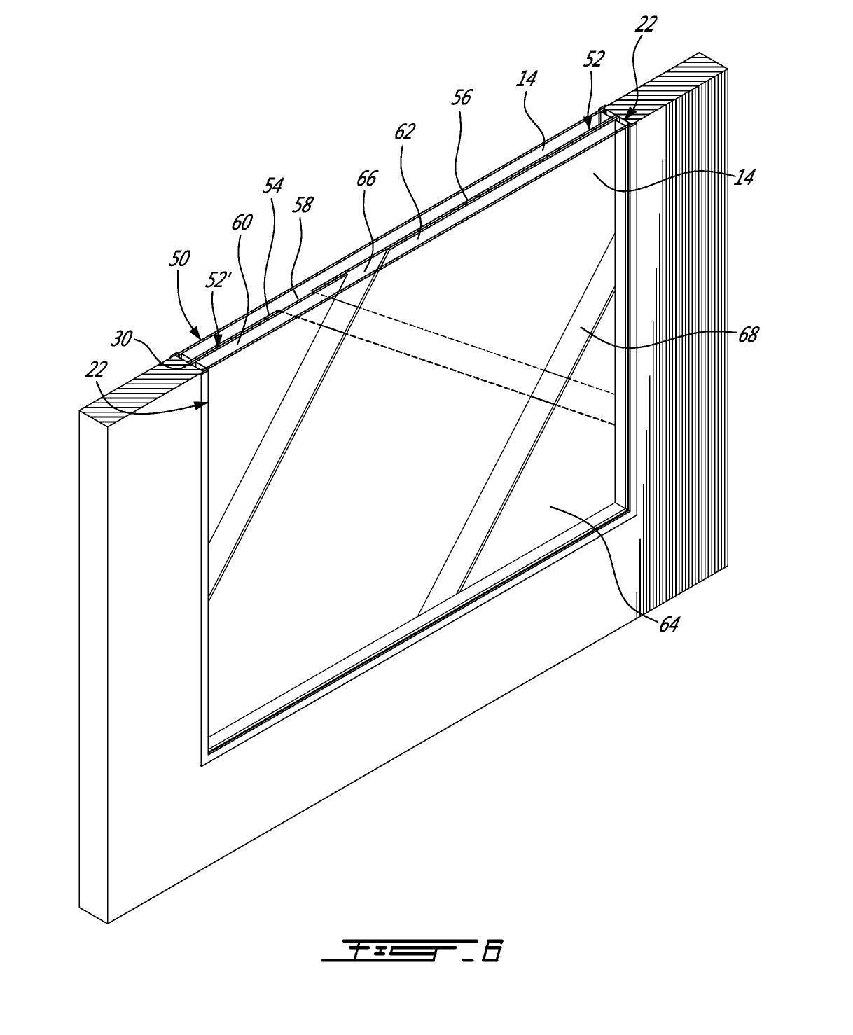

With reference to FIG. 6, a stained glass assembly 50 according to a third illustrative embodiment will now be described. Since the assembly 40 is similar to the assembly 11, only the differences therebetween will be described herein for concision purposes.

The assembly 50 includes two superimposed pieces of glass sub-assemblies 52-52′ sandwiched between two full size pieces of glass 14. Each of the sub-assemblies 52-52′ includes two or more pieces of glass or of other materials and defines a decorative pattern. The superposition of the two sub-assemblies 52 and 52′ results in a further decorative pattern.

As can be seen in FIG. 6, the first sub-assembly 52 has two distanced glass pieces 54 and 56 having a gap 58 therebetween. The second sub-assembly 52′ has three distanced glass pieces 60, 62 and 64, each two adjacent pairs 60-62 and 62-64 having a gap 66 and 68 therebetween. The pieces 54-56 and 60-64 are so configured and relatively positioned that the gap 58 intersects both gaps 66 and 68 in a superimposed fashion.

According to the embodiment shown in FIG. 6, both sub-assemblies are received, at least on two opposite sides thereof, in a same slot 30 of a single retaining channel 22. As mentioned hereinabove, the two full size pieces of glass 14 can be omitted.

According to another embodiment (not shown), the retaining channels 22 include two (2) glass pieces receiving slots 30, defined by three (3) tubular sections 26 joined by bridges.

According to still another embodiment, the stained glass assembly includes three or more sub-assemblies of glass pieces (not shown), having different configurations and/or made of pieces of glass of different colors, from different materials and/or from any combination thereof.

According to some embodiments, the retaining channels are not secured to the frame but are integral thereto.

It is to be understood that embodiments of the stained glass assembly are not limited in their applications to the details of construction and parts illustrated in the accompanying drawings and described hereinabove. Other embodiments can be foreseen and practiced in various ways. It is also to be understood that the phraseology or terminology used herein is for the purpose of description and not limitation.

What is claimed is:

1. A stained glass assembly comprising
at least two flat pieces mounted within a frame and being secured in at least one retaining channel that extends at least partially along the inner periphery thereof; and
spacers in the at least one retaining channel between each pair of the at least two flat pieces that are adjacent so as to create an opened gap therebetween.

2. The Stained glass assembly recited in claim 1, wherein the at least one retaining channel includes two deformable sections distanced by a bridge section defining a slot for receiving the at least two flat pieces.

3. The stained glass assembly recited in claim 2, wherein at least one of the two deformable sections is convex on a side of the bridge section, yielding a slot having a section along its depth that is narrower than the at least two flat pieces.

4. The stained glass assembly recited in claim 3, wherein at least one of the two deformable sections is tubular.

5. The stained glass assembly recited in claim 2, wherein at least one of the spacers is in the form of protrusions within the at least one retaining channel.

6. The stained glass assembly recited in claim 1, wherein the at least one retaining channel is made of a metal or a polymer.

7. The stained glass assembly recited in claim 1, wherein the at least one retaining channel includes a plurality of retaining channels, each extending along a portion of the inner periphery of the frame.

8. The stained glass assembly recited in claim 1, wherein the at least one retaining channel defines two side-by-side slots, one for receiving the at least two flat pieces and the other for receiving at least two other flat pieces.

9. The stained glass assembly recited in claim 1, wherein the at least one retaining channel extends substantially along the entire inner periphery of the frame.

10. The stained glass assembly recited in claim 1, wherein the at least one retaining channel is secured to the frame using at least one of fasteners and an adhesive.

11. The stained glass assembly recited in claim 1, wherein the at least one retaining channel is integral to the frame.

12. The stained glass assembly recited in claim 1, wherein at least one of the spacers is in the form of an element inserted in the at least one retaining channel.

13. The stained glass assembly recited in claim 1, wherein at least some of the spacers are in the form of protrusions in the at least one retaining channel.

14. The stained glass assembly recited in claim 1, wherein at least one of the at least two flat pieces includes at least one of a metallic material and a polymeric material.

15. The stained glass assembly recited in claim 1, wherein at least one of the at least two flat pieces is transparent, frosted, colored, provided with marks, provided with a pattern, or any combination thereof.

16. The stained glass assembly recited in claim 1, wherein at least one of the at least two flat pieces is a glass panel.

17. A door provided with at least one stained glass assembly as recited in claim 1.

18. The door as recited in claim 16, wherein the at least one stained glass assembly defines a first decorative panel sandwiched between two glass panels.

19. The door as recited in claim 18, wherein the at least one stained glass assembly includes a plurality of stained glass assemblies that are superimposed between the two glass panels.

20. A dividing wall provided with at least one stained glass assembly as recited in claim 1.

21. The door as recited in claim 20, wherein the at least one stained glass assembly defines a first decorative panel sandwiched between two glass panels.

22. The door as recited in claim 21, wherein the at least one stained glass assembly includes a plurality of stained glass assemblies as recited in claim 1 that are superimposed between the two glass panels.

23. A stained glass assembly comprising glass pieces mounted to a frame via retaining channels; the retaining channels having spacers therein for maintaining gaps between adjacent glass pieces.

24. A stained glass assembly comprising:
at least two flat pieces of glass mounted within a frame and being secured in at least one retaining channel that is mounted to the frame so as to extend at least partially along the inner periphery thereof; the at least one retaining channel including two deformable sections distanced by a bridge section defining a slot for receiving the at least two flat pieces; and
spacers in the at least one retaining channel between each pair of the at least two flat pieces of glass that are adjacent so as to create an opened gap therebetween.
